(19) United States
(12) Patent Application Publication
(10) Pub. No.: US 2010/0316033 A1
(43) Pub. Date: Dec. 16, 2010

(54) ENHANCEMENTS FOR OFF-THE-SHELF 802.11 COMPONENTS

(76) Inventor: Peter Atwal, Longwood, FL (US)

Correspondence Address: STRATEGIC PATENTS P.C.., C/O PORTFOLIOIP, P.O. BOX 52050, MINNEAPOLIS, MN, 55402, US

(21) Appl. No.: 12/817,114

(22) Filed: Jun. 16, 2010

Related U.S. Application Data
(60) Provisional application No. 61/187,656, filed on Jun. 16, 2009.
(60) Provisional application No. 61/313,723, filed on Mar. 13, 2010.

(51) Int. Cl. H04W 84/02

(52) U.S. Cl. 370/338

(57) ABSTRACT

Methods and systems are disclosed for deploying mobile ad hoc networks using commercial off-the-shelf components conforming to the IEEE 802.11-2007 networking standard. In particular, a physical layer (which may be implemented in hardware, software, or a combination of these) is provided at or below the MAC layer that adapts operation of standard chipsets to an enhanced ad hoc wireless networking protocol such as the MBRI protocol described herein. This may include suppressing or disabling certain operations of the 802.11 chipset, and adding other functions to support augmenting functionality of the protocol stack to provide various higher-level network functions (e.g., network, routing, and other functions) of an enhanced protocol within or through the physical layer. In one aspect, there is disclosed herein a method for operating a network device that includes disabling at least one function of an 802.11 chipset and providing at least one additional network function through a physical layer application programming interface for the 802.11 chipset.

### CROSS-REFERENCE TO RELATED APPLICATIONS

This application claims the benefit of U.S. Provisional Application Ser. No. 61/187,656, filed on Jun. 16, 2009 and U.S. Provisional Application Ser. No. 61/313,723, filed on Mar. 13, 2010, each of which is incorporated herein by reference in its entirety.

### BACKGROUND

Existing wireless communications used in carrier-grade networks typically consist of a cell-based infrastructure where all mobile subscriber nodes must communicate directly with a network base station. As an alternative, wireless communications (such as the well known WiFi networks) may utilize a mobile ad hoc network (MANET), where any mobile node can communicate with any other node, either directly or through multiple hops across the network topology. However, existing mobile ad hoc networks sometimes operate without any network infrastructure on a single fixed spectrum channel. There exists a need to provide mobile broadband routable internet (MBRI) networks with integrated WiFi.

In addition, the proliferation of WiFi devices had led to cheaply available chipsets implementing various aspects of the IEEE 802.11 WiFi standards. There exists a further need for adaptations of existing 802.11 hardware for use with ad hoc networks such as MBRI.

### SUMMARY

Methods and systems are disclosed for deploying mobile ad hoc networks using commercial off-the-shelf components conforming to the IEEE 802.11-2007 networking standard. In particular, a physical layer (which may be implemented in hardware, software, or a combination of these) is provided at or below the MAC layer that adapts operation of standard chipsets to an enhanced ad hoc wireless networking protocol such as the MBRI protocol described herein. This may include suppressing or disabling certain operations of the 802.11 chipset, and adding other functions to support augmenting functionality of the protocol stack to provide various higher-level functions (e.g., network, routing, and other functions) of the MBRI protocol within or through the physical layer. In one aspect, there is disclosed herein a method for operating a network device that includes disabling at least one function of an 802.11 chipset and providing at least one additional network function through a physical layer application programming interface for the 802.11 chipset.

### BRIEF DESCRIPTION OF THE FIGURES

The invention and the following detailed description of certain embodiments thereof may be understood by reference to the following figures:

FIG. 1A depicts an embodiment of a collection of wireless radio nodes in a mobile ad-hoc wireless network according to an embodiment of the present invention.

FIG. 1B depicts an embodiment of a collection of wireless radio nodes in a mobile ad-hoc wireless network according to an embodiment of the present invention, where the radio nodes are shown as nodes linked together into the mobile ad-hoc wireless network.

FIG. 2A depicts an embodiment of a wireless mesh network according to an embodiment of the present invention, where access points are shown in relation to the network's connection to a fixed network.

FIG. 2B depicts embodiment of a wireless mesh network according to an embodiment of the present invention, where subscriber nodes are shown linked to access points.

FIG. 3 depicts an embodiment of a wireless network with access points back to the fixed Internet.

FIG. 4 depicts an embodiment of a wireless network showing multiple pathways from a particular mobile network node to the fixed Internet.

FIG. 5 depicts an embodiment of the MBRI stack showing layers from device down to physical layer.

FIG. 6 depicts an embodiment of the MBRI stack showing the addition of DySAN capabilities.

FIG. 7 depicts an embodiment of the use of dynamic spectrum access technology to wireless communication according to an embodiment of the present invention.

FIG. 8 depicts an embodiment of the mobile ad-hoc wireless network using dynamic spectrum access technology according to an embodiment of the present invention.

FIG. 9 depicts an embodiment of DySAN spectrum aware routing.

FIG. 10 depicts coexistence of MBRI and WiFi.

FIG. 11 depicts temporal avoidance according to one embodiment of the present invention.

FIG. 12 depicts full frequency avoidance according to one embodiment of the present invention.

FIG. 13 depicts partial frequency avoidance according to one embodiment of the present invention.

FIG. 14 depicts multiple levels of multi-mode device integration according to one embodiment of the present invention.

FIG. 15 depicts another view of the MBRI protocol stack according to one embodiment of the present invention.

FIG. 16 illustrates a slotted TDMA timing structure according to one embodiment of the present invention.

FIG. 17 is a block diagram of an exemplary MBRI-802.11 PHY layer integration according to one embodiment of the present invention.

FIG. 18 shows an apparatus adapting an OTS 802.11 chipset to use with an enhanced network protocol.

FIG. 19 shows a flow chart of a process for communicating in a wireless ad hoc network using an 802.11 chipset.

### DETAILED DESCRIPTION

The present disclosure provides a mobile broadband routable internet (MBRI) for providing carrier-grade, networked, broadband, IP-routable communication among a plurality of mobile devices, where the mobile devices may represent a plurality of nodes that are linked together through a mobile ad hoc network (MANET). Mobile devices, also referred to herein where context permits as subscriber devices, may operate as peers in a peer-to-peer network, with full IP routing capabilities enabled within each subscriber device, thereby allowing routing of IP-based traffic, including deployment of applications, to the subscriber device without need for infrastructure conventionally required for mobile ad hoc networks, such as cellular telephony infrastructure. Full IP-routing to subscriber devices allows seamless integration to the fixed Internet, such as through fixed or mobile access points, such as for backhaul purposes. Thus, the MBRI may function as a standalone mobile Internet, without connection to the fixed Internet, or as an IP-routable extension of another network, whether it be the Internet, a local area network, a wide area network, a cellular network, a personal area network, or some other type of network that is capable of integration with an IP-based network. The capabilities that enable the MBRI are disclosed herein, such capabilities including the software, technology components and processes for physical (PHY) layer, media (or medium) access control (MAC) layer, and routing (or network) layer capabilities that allow all IP-based traffic types and applications to use the MBRI, embodied across a set of mobile devices, as if it were an 802.1 through 802.3 compliant fixed network, without reliance on, or intervention by, fixed network infrastructure components such as application-specific Internet servers or cellular infrastructure components.

The features of the present invention, which are believed to be novel, are set forth with particularity in the appended claims. The invention may best be understood by reference to the following description, taken in conjunction with the accompanying drawings.

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defied as one or more than one. The term “another,” as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

### MANET and the MBRI Protocols

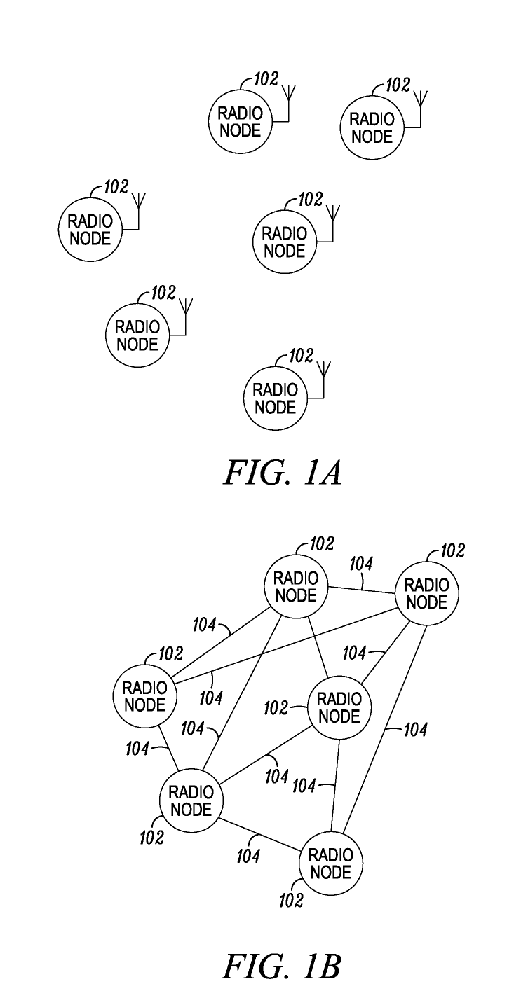

FIG. 1A illustrates a Mobile Ad Hoc Wireless Network (MANET) as used in embodiments of the present invention. Such networks are known in the art and are described in detail in, for example, U.S. application Ser. No. 12/418,363, filed on Apr. 3, 2009 and incorporated herein by reference in its entirety. As shown in FIG. 1A, the wireless network may have a set of wireless devices capable of communicating wirelessly. Each wireless device may be termed as a node 102. A node 102 may communicate with any other node 102, and as shown in FIG. 1B, links 104 may be formed between nodes 102. The mobile ad-hoc network may include nodes 102 that are mobile, as well as nodes 102 that are fixed. In embodiments, the fixed nodes may enable the creating of a spanning network to establish initial wireless coverage across a geographic area. In addition, a subset of these nodes 102 may have connectivity to a fixed (i.e., wired) network. In a mobile ad-hoc wireless network, routing through the network may find the ‘best’ path to destination including ‘multi-hop’ relay across multiple wireless nodes. The wireless network may be capable of autonomously forming and re-forming links and routes through the network. This dynamic forming and re-forming of links 104 and routes may be made to adjust to changing conditions resulting from node mobility, environmental conditions, traffic loading, and the like. Thus, mobile ad-hoc wireless network's wireless topology may change rapidly and unpredictably.

Establishing a quality of service may be an essential quality for the mobile ad-hoc wireless network. In embodiments, quality of service for a mobile ad-hoc wireless network may be measured in terms of the amount of data that the network successfully transfers from one place to another over a period of time. Currently used mobile ad-hoc networks may have a number of issues with respect to network quality of service, such as application routing-focused communication without the ability to provide service-level agreements for quality-of-service, providing only unicast services, link-focused power control, providing a single data rate only, providing contention-based access (e.g., focus on inefficient unlicensed band radios), focused on military or public safety applications, congestion and dynamic and unpredictable latency (especially with multi-hop scenarios), and the like. In embodiments, the present invention may provide for a mobile ad-hoc network that significantly improves on the shortcomings of current systems.

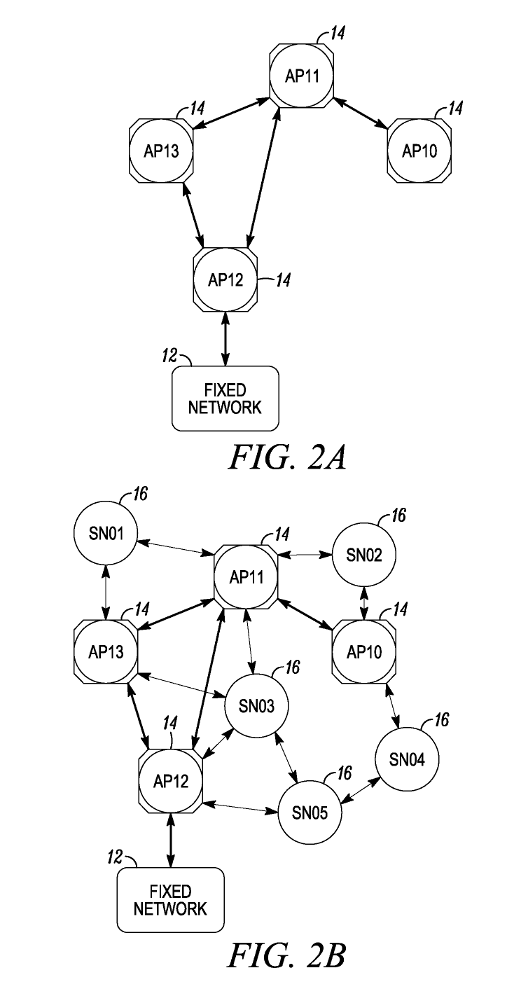

FIGS. 2A and 2B illustrate a wireless mesh network according to an embodiment of the present invention. The wireless mesh network may be a type of wireless ad-hoc network that allows multi-hop routing. Wireless mesh network architecture may sustain communications by breaking long distances into a series of shorter hops. As shown in FIG. 2A, the wireless mesh network may have a subset of nodes 102 designated as access points 14 to form a spanning network to establish initial wireless network coverage across a geographical area. In an embodiment, one or more access points may have a connection interface to a fixed network 12. In embodiments, the fixed network 12 that the access points 14 connect to may be any known fixed network, such as the Internet, a LAN, a WAN, a cell network, and the like. As shown in FIG. 2B, a subset of nodes 102 may be designated as ‘subscriber nodes’ 16 that may form links 104 among themselves and to the spanning network to augment wireless coverage. This may allow nodes 102 connectivity to the fixed network 12 via multiple hops across wireless topology. This topology may also change with node mobility. In embodiments, a wireless mesh network may be termed as a mobile ad-hoc network if the nodes 102 in a wireless mesh network are mobile.

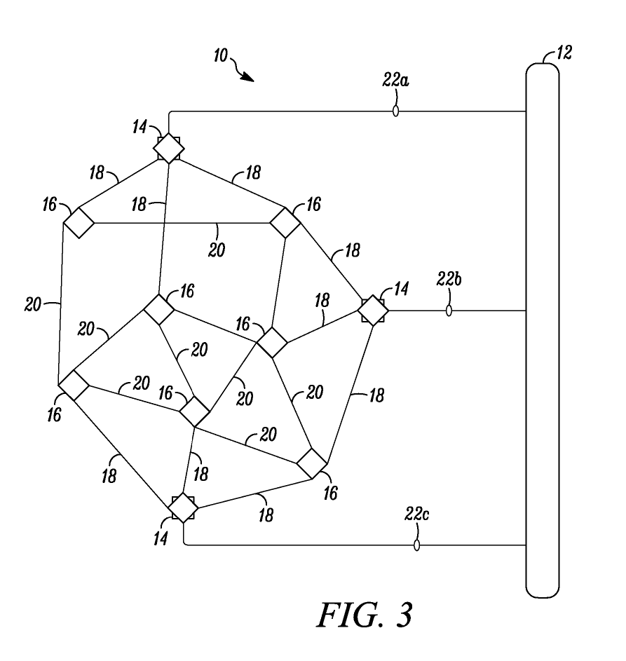

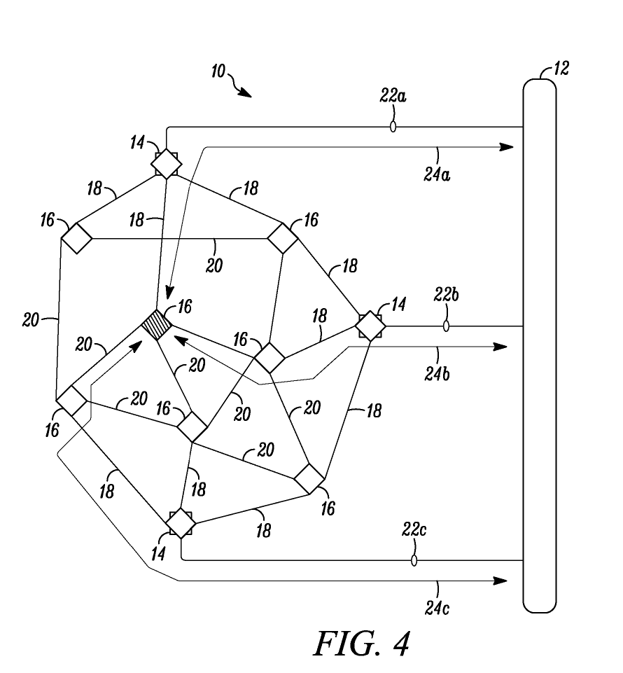

FIG. 3 depicts a mobile ad-hoc network with backhaul 10 to a fixed network 12. Here, the mobile ad-hoc network is shown to include a plurality of mobile nodes 16, a plurality of fixed nodes 14, a plurality of access points 14, a plurality of mobile node to fixed node links 18, a plurality of mobile node to mobile node links 20, the fixed network 12, and a plurality of fixed node to fixed network links 22a-c. In embodiments, the fixed nodes 14 may provide network structure, such as to provide a spanning network that enables the establishment of the ad-hoc network, as well as connectivity to the fixed network. Mobile nodes 16 may then establish links 18 to both fixed nodes 14 and to other mobile nodes 20, where all of the nodes 14,16 and links 18, 20 establish the mobile ad-hoc network with links 22a-c to the fixed network 12. FIG. 4 illustrates three example network pathway routings 24a-c for a mobile node 16 establishing connectivity to the fixed network 12, including a link combination 24a from the fixed network 12 to a fixed node 14 and then to the destination mobile node 16, a link combination 22b to a fixed node 14 through an intermediate mobile node 16 and then to the destination mobile node, and an alternate link combination 22c to a fixed node 14 through an intermediate mobile node 16 and then to the destination mobile node. In embodiments, the link combinations may include any number of mobile nodes 16, fixed nodes 14, subscriber nodes, access points, and the like.

In embodiments, the mobile ad-hoc network may also provide a plurality of network services and attributes, such as autonomous neighbor discovery and maintenance, distributed network timing reference dissemination, dynamic frame structure, distributed scheduling with dynamic selection of scheduling algorithms (e.g., such as based on network topology, traffic load, spectrum availability), link-by-link autonomous data rate selection, traffic differentiation across the protocol stack (e.g. priority queuing and priority channel access), ARQ automatic repeat and request capability, geo-location capability for E-911 and location-based services, power control for intra-network interference management and spectrum reuse, unicast and multicast routing, interfacing in a standard way to existing IP core network nodes, encryption and authentication, OSS with EMS and NMS, and the like.

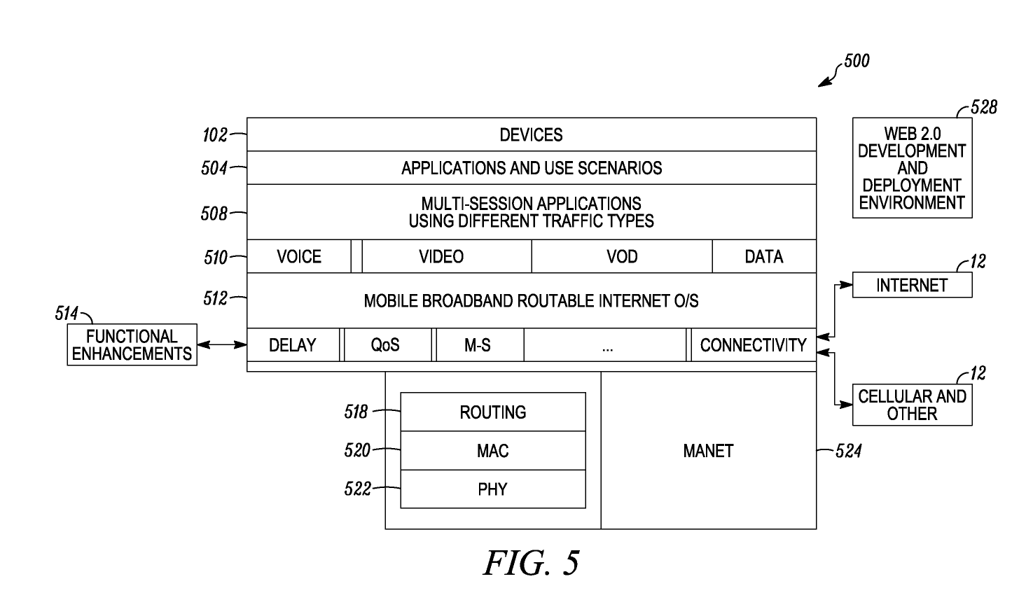

FIG. 5 depicts the MBRI as a hierarchical stack 500. At the top of the MBRI stack are the devices 102, including mobile subscriber devices (SD) 16, fixed node communication devices, access points 14, and the like. The next two layers down represent applications and use scenarios 504, and multi-session applications using different traffic types 508, which may be utilized or executed by the devices 502 in conjunction with the MBRI. Continuing down to the next layer, are data applications that may be carried 510 across the MBRI, including data, voice, video, video on demand (VOD), and the like. Next is the MBRI operating system 512. Next, the MBRI stack shows a representative subset of the MBRI functional enhancements 514, as described herein, which may be provided as optional elements in the MBRI system. The MBRI thus far, may then be enabled from the stack elements below, including a core stack of routing 518, MAC 520, and physical layers 522, as shown in the middle, which may provide fixed Internet equivalency in a mobile ad-hoc network 524. In addition, connectivity is also shown to other communication facilities, such as the fixed networks 12 as described herein. In embodiments, the MBRI may be built up from various combinations and sub-combinations of the various components of the MBRI stack, which may enable various applications, devices, and the like, the ability to deploy applications directly to the device. In embodiments, the MBRI stack may provide a solution with high quality of service transport for multi-session applications, replicate functions that may be effectively analogous to the foundation standards of the IETF defined internet within the mobility sector, enable functions analogous to each of the functions in the IETF 802.1-3 fixed Internet stack provide services associated with Web 2.0 development and deployment environment 528, and the like. In embodiments, the MBRI may represent a mobile ad-hoc network with true Internet routing capability.

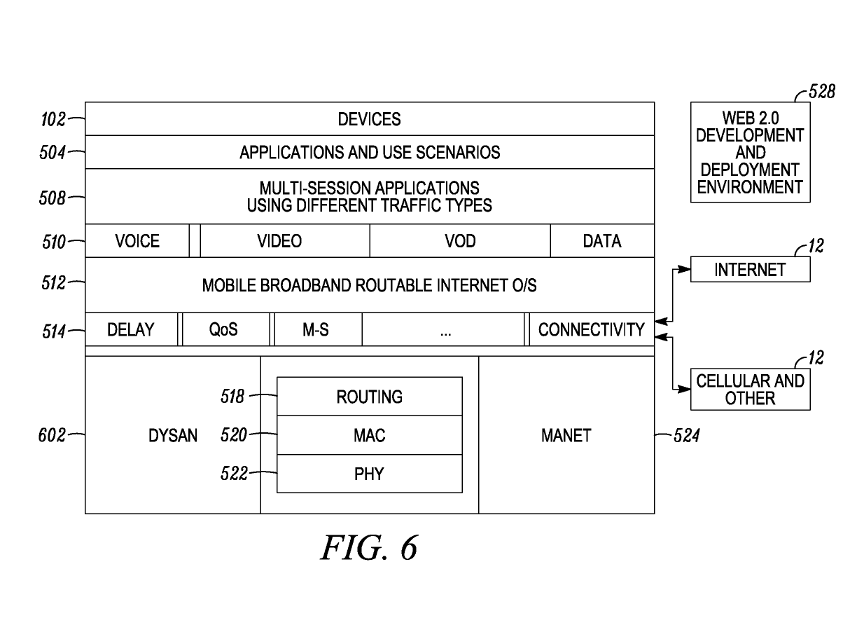

FIG. 6 shows the MBRI stack as introduced in FIG. 5, but with dynamic spectrum access (DySAN) 602 added as an option. Currently dynamic spectrum access technologies may be focused on limited aspects of network performance, such as on TV bands, finding spectrum for the whole network, trying to avoid interference through power control, and the like. Dynamic spectrum access 602, as a part of MBRI, may provide spectrum used to communicate wirelessly between nodes changes in a non-pre-determined manner in response to changing network and spectrum conditions. In embodiments, the time scale of dynamics may be typically less than can be supported by engineering analysis, network re-planning, optimization, and the like. For instance, in response to manual or automated decisions, where there may be centralized decisions (e.g., network partitioning) or distributed local decisions of the individual nodes. Dynamic spectrum access may be able to avoid interference to/from geographically proximate spectrum users internal or external to their own wireless network. Dynamic spectrum access 602 may also be able to access and utilize spectrum otherwise unavailable for wireless network use. In embodiments, local spectrum decisions may be coordinated and/or communicated using a fixed or logical control channel in an over-the-air wireless network.

DySAN technology encompasses a set of techniques for spectrum sharing described by way of example and not limitation in the following documents: U.S. patent application Ser. Nos. 11/595,719, filed on Nov. 10, 2006; 11/548,763, filed on Oct. 12, 2006; 11/595,493, filed on Nov. 10, 2006; 11/772,691, filed on Jul. 2, 2007; 11/595,542, filed on Oct. 6, 2006; 11/595,716, filed on Nov. 10, 2006; 11/595,717, filed on Nov. 10, 2006; and 11/595,740, filed on Nov. 10, 2006, each of which is incorporated herein by reference in its entirety,

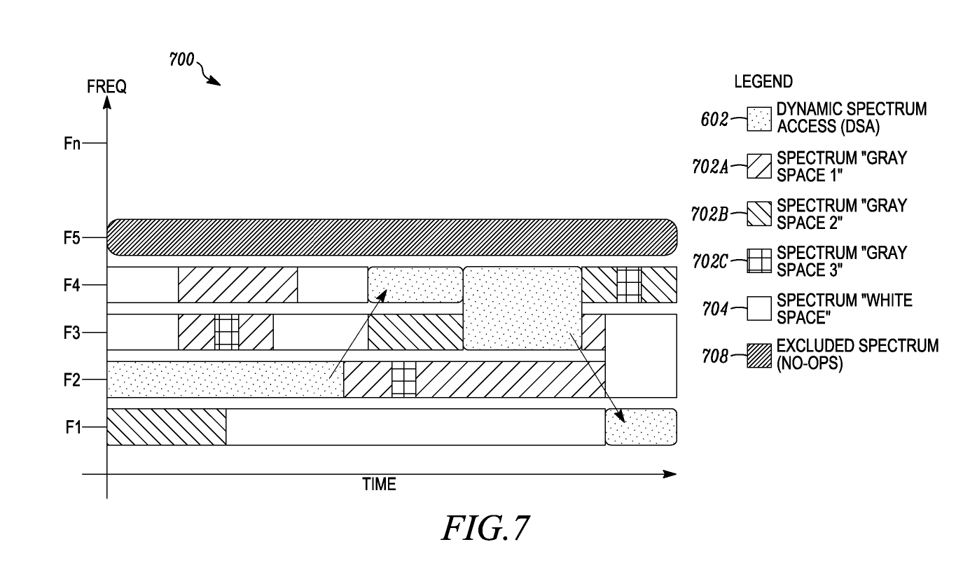

FIG. 7 illustrates the use of dynamic spectrum access technology 700 to wireless communication according to an embodiment of the present invention. A wireless network may use dynamic spectrum access that provides a dynamic allocation of wireless spectrum to network nodes, such as between the different frequencies F1, F2, F3, F4, and F5. The spectrum may be used to communicate wirelessly between nodes 102 in a non-pre-determined manner in response to changing network and spectrum conditions. Dynamic spectrum access technology may use the methodology of coordination of a collection of wireless nodes 16 to adjust their use of the available RF spectrum. In embodiments, the spectrum may be allocated in response to manual or automated decisions, such as to dynamic spectrum access 602, spectrum gray space 702A, 702B, and 702C, spectrum white space 704, excluded spectrum 708 (e.g. no ops). The spectrum may be allocated in a centralized manner (e.g., network partitioning) or in a distributed manner between individual nodes. The spectrum may be allocated dynamically such that interference to/from geographically proximate spectrum users internal or external to the wireless network may be avoided. The local spectrum decisions may be coordinated/communicated using a fixed or logical control channel in the over-the-air wireless network. This may increase the performance of wireless networks by intelligently distributing segments of available radio frequency spectrum to wireless nodes. Dynamic spectrum access may provide an improvement to wireless communications and spectrum management in terms of spectrum access, capacity, planning requirements, ease of use, reliability, avoiding congestion, and the like.

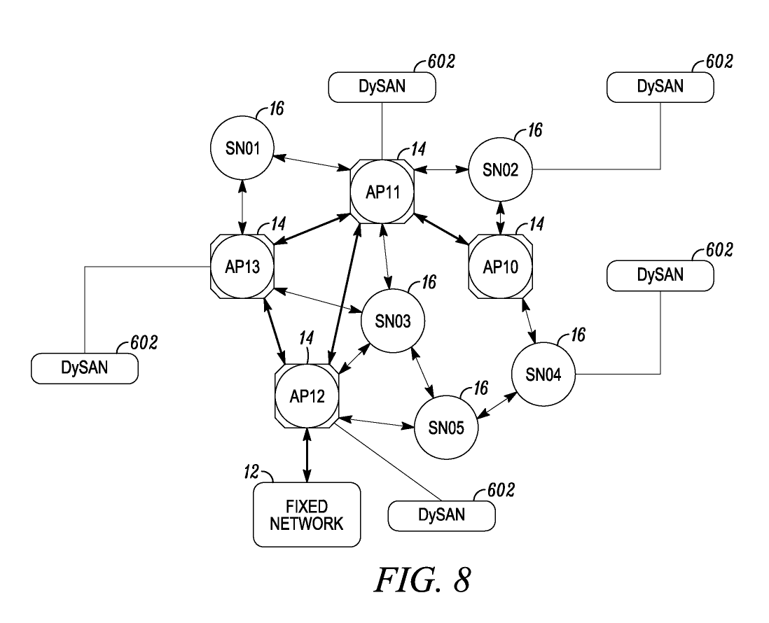

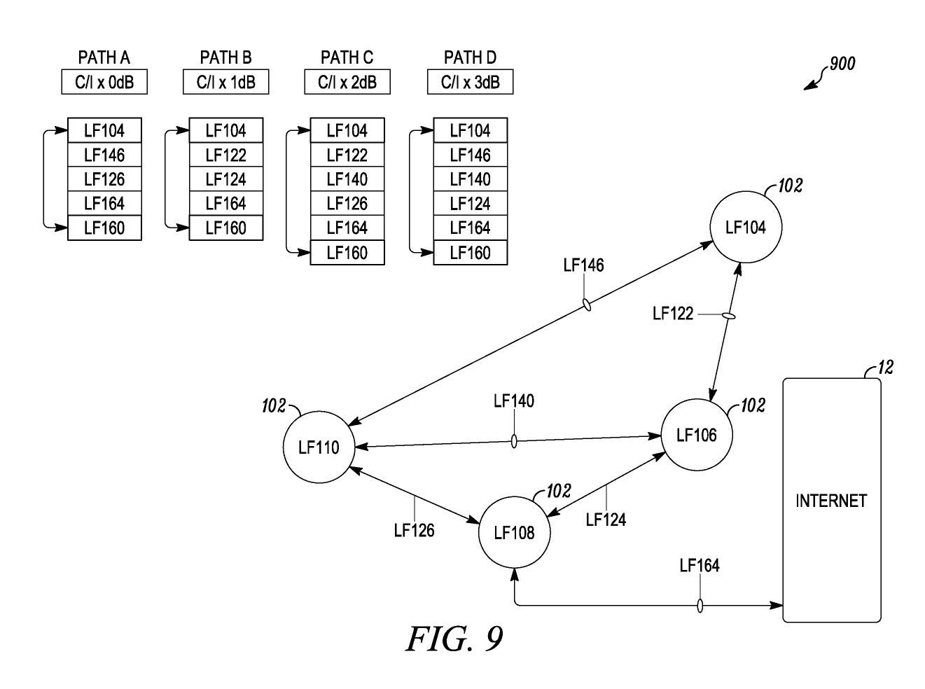

FIG. 8 illustrates a mobile ad-hoc wireless network using dynamic spectrum access technology 602 according to an embodiment of the present invention. In this embodiment, a mobile ad-hoc wireless network may be used in conjunction with dynamic spectrum access technology 602 to provide carrier grade quality of service. A collection of wireless nodes 14, 16 in a mobile ad-hoc network is shown dynamically adapting spectrum usage according to network and spectrum conditions. Individual nodes in the mobile ad-hoc wireless network may make distributed decisions regarding local spectrum usage. In embodiments, quality of service for a mobile ad-hoc wireless network may be measured in terms of the amount of data which the network may successfully transfer from one place to another in a given period of time, and DySAN 602 may provide this through greater utilization of the available spectrum. In embodiments, the dynamic spectrum access technology may provide a plurality of network services and attributes such as, coordinated and uncoordinated distributed frequency assignment, fixed or dynamic network coordination control channel, assisted spectrum awareness (knowledge of available spectrum), tunable aggressiveness for co-existence with uncoordinated external networks, policy-driven for time-of-day frequency and geography, partitioning with coordinated external networks, integrated and/or external RF sensor, and the like. FIG. 9 shows how a spectrum aware path may be selected based on carrier-to-interference ratio 900, in this instance measured in dB (×0 to ×3). Basic Encoding Rules (BER) may be used as well to reduce bit errors.

In embodiments, the present invention may implement a method for providing a mobile, broadband, routable internet (MBRI), in which a plurality of mobile devices interact as nodes in a mobile ad hoc network and in which packets are IP routable to the individual device independent of fixed infrastructure elements; enhancing MBRI operation through the use of dynamic adaptation of the operating spectrum; and disseminating spectrum access decisions through use of a logical control channel. In embodiments, adaptation decisions may be made by a centralized controller, in a distributed manner, and the like.

In embodiments, the present invention may implement a system for a mobile, broadband, routable internet (MBRI), in which a plurality of mobile devices interact as nodes in a mobile ad hoc network and in which packets are IP routable to the individual device independent of fixed infrastructure elements; the network capable of enhancing MBRI operation through the use of dynamic adaptation of the operating spectrum; and the network capable of disseminating spectrum access decisions through use of a logical control channel. In embodiments, adaptation decisions may be made by a centralized controller, a distributed manner, and the like.

In embodiments, the MBRI may provide enhancements that better enable carrier-grade service, such as through prioritization of latency-sensitive traffic across multiple layers of the networking protocols to reduce end-to-end latency and jitter (such as by providing priority queuing within node, priority channel access at MAC across nodes and priority routing across topology), providing network support for peer-to-peer connections bypassing network infrastructure, unicast and multicast routing with multiple gateway interfaces to fixed (i.e., wired) network, providing security to protect control-plane and user data and prevent unauthorized network access, traffic shaping and policing to prevent users from exceeding authorized network usage, remote monitoring, control, and upgrade of network devices, automatic re-transmission of loss-sensitive traffic, transparent link and route maintenance during periods of spectrum adaptation, rapid autonomous spectrum adaptation to maintain service quality, avoid interference, and maximize capacity, scalability of network protocols for reliable operation with node densities (e.g., hundreds to thousands of nodes per sq. km.) and node mobility (e.g., to 100 mph) consistent with commercial wireless networks, using adaptive wireless network techniques to maximize scalable network capacity (e.g., adaptive transmit power control to reduce node interference footprint, adaptive link data rate, dynamic hybrid frame structure, dynamic distributed scheduling techniques, multi-channel operation using sub-channels and super-channels, load-leveling routing), simultaneous support of multiple broadband, high mobility network subscribers, interfaces with fixed carrier network (e.g., to support VoIP, SIP, etc.), and the like.

### Coexistence

The presently-disclosed Mobile Broadband Routable Internet (MBRI) solution—in contrast to conventional wireless and fixed wired access networks—may provide for a mobile broadband internet network solution where every subscriber device and infrastructure node may have routing capabilities to allow for intelligent routing decisions enabling intra-network peer-to-peer communications. Traffic between nodes of the MBRI may not need to leave the MBRI network for routing or switching purposes. Instead, because MBRI may be routing enabled, local traffic including required signaling will stay within the MBRI. Also, MBRI allows for inter-network routing since it provides transparent Internet routing capabilities for well known and established internet standards such as Border Gateway Protocol (BGP), Open Shortest Path First (OSPF) routing protocol, Address Resolution Protocol (ARP), Dynamic Host Configuration Protocol (DHCP) and Point to Point Packet (PPP) transmission protocol.

In addition, because of its unique neighbor discovery management and adaptive data rate and power management capabilities, the MBRI may enable local intelligence to be shared across its member nodes leading to the creation and deployment of new classes of services and applications.

Further, because of its Mobile Ad hoc Network (MANET) characteristic, the MBRI may be independent of fixed traffic aggregation points such as WiFi access points, WLAN switches, and/or WiFi routers, and instead can leverage existing MBRI or WiFi access points for backhaul in a load leveling and self-healing manner. Because of the MANET waveform characteristics and the MANET architectural flexibility to deploy additional Backhaul Access Points or to upgrade existing MANET Access Points with backhaul capability, the MBRI may assure broadband bandwidth to the individual SD/MAP nodes in excess of conventional third generation or fourth generation (3G/4G) networks.

If combined with Dynamic Spectrum Awareness Networking (DySAN) protocol technology, the MBRI may coexist within existing defined spectrum with associated active network operations including WiFi networks. The present MBRI network may be integrated into or interoperate with and coexist with existing WLAN networks, Public Safety networks and sensor networks that are based on the IEEE 802 series standards such as 802.11 WiFi. DySAN may monitor and report on all aspects of the available RF spectrum to a host radio system including reporting, tracking, and proactively using spectrum that is available under a secondary usage or non-assured basis or on an opportunistic usage basis.

Integration options include a tightly coupled approach where the MBRI may act as a master controller for WiFi network with switching, where both radio systems share common radio resources such as the radio front end, antenna, baseband processing elements, or a loosely coupled arrangement where MBRI acts as a separate radio access and backhaul network to the WiFi network operations. Even when MBRI may be set up as a separate radio access network the spectrum can be shared in a cooperative or non-competing manner through the use of DySAN functionality within the MBRI technology.

The MBRI network may be set up in several configuration options with WiFi including:
A loosely coupled MBRI network integration option in which MBRI may only terminate calls or originate calls within the MANET, and similarly WiFi may only terminate and originate calls on the WiFi network, and there may be no call handoff capability between the networks, but transport facilities may be co-shared e.g. backhaul fiber transport.
A fully integrated MBRI network option where MBRI may provide time and frequency slots to the WiFi for full WiFi operations concurrently with MBRI usage using DySAN as a control mechanism to operate both networks concurrently.
A semi integrated MBRI and WiFi solution where the MBRI may share the WiFi AP's for transport for backhaul traffic to/from the Internet and may maintain the MANET operation on the access side. Or, vice versa, the MBRI network may provide backhaul support for existing WiFi by acting as a WiFi relay network or backhaul network.

The MBRI network configuration options above may share the same spectrum or different spectrum under a variety of regimes including:
Separate non-overlapping frequency bands
Co-shared bands under DySAN control
Secondary emitter status where either technology may be set up as the primary frequency and DySAN may be used to control the other technology as the secondary emitter based on data throughput requirements, signal quality requirements, time of day requirements, geographic separation or spatial variances

MBRI may be added as underlay or overlay network to increase tele-density, spectrum reuse, and capability in existing WiFi networks without requiring further spectrum purchases and expensive upgrades to the existing networks. MBRI as an underlay may reuse existing spectrum by recovering available white space based on DySAN policy control and spectrum awareness or through spectrum sharing within an existing network, and may optimize the use of existing facilities.

MBRI as an overlay may be used for “hole filling” between for WLAN coverage. In this manner, the spectrum used may be spatially or geographically separate and DySAN may or may not be important. Options for reusing existing facilities and/or databases may be the choice of the integration entity; all options are possible within the scope and spirit of the present invention.

Each node in an MBRI may act as its own name server in its own IP domain, supports filing services, may leverage distributed databases (via the Internet) and has access to geolocation information. Therefore, an individual MBRI node may act as its own radio access network, IP domain and/or underlay or overlay node in an existing WiFi/WLAN network, Public Safety network or sensor network (providing it may access the wired Internet via MBRI MAPs/BAPs or through shared facilities). MBRI may be integrated with WiFi and may act as a backhaul network for WiFi nodes or use WiFi nodes for backhaul transport services and/or allow for concurrent WiFi operation by providing DySAN support. With DySAN, an MBRI node may be able to provide spectrum time slots and frequency segments for WiFi operation. The MBRI router layer may support concurrent WiFi and/or MBRI MAC-PHY layer operations, in addition each network MAC-PHY may be implemented separately down to the chip level or the WiFi MAC may be implemented as a subset of the MBRI MAC. Note the PHY layer operations may require their own separate baseband RF processing elements.

MBRI WiFi integration and coexistence may be achieved in multiple different ways for loose or tight coupling. Spectrum sharing may only be performed through spectrum splitting (a crude option) or via DySAN. The present MBRI has much more flexibility in allowing open and proprietary extensions to the MBRI nodes at the BAP, MAP, or SD level since all nodes may support a service open architecture and open web applications downloading.

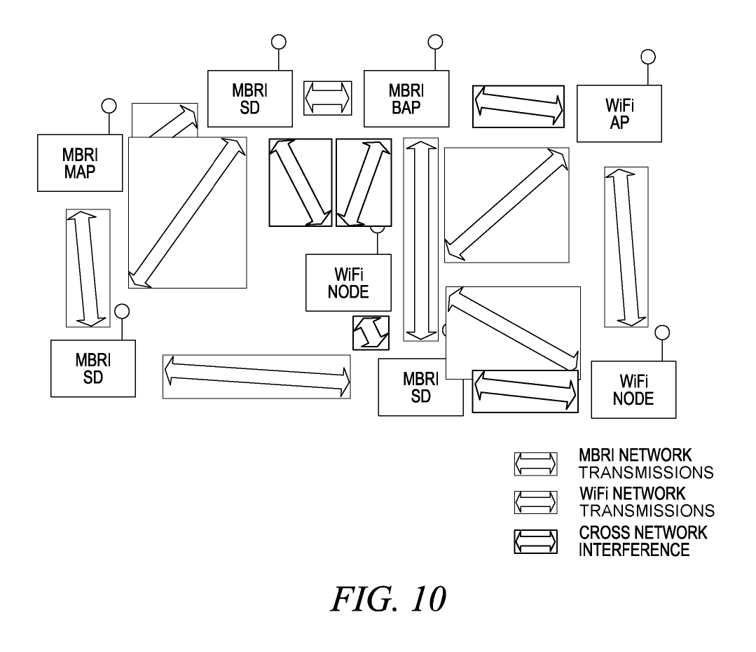

Coexistence is illustrated by reference to FIG. 10. Here, the MBRI and WiFi networks may operate in the same areas and in the same frequency band(s). Since there is no explicit coordination between networks, separate networks with different wireless ‘personalities’ cannot directly exchange messages over-the-air. Co-channel, partially overlapping, and adjacent channel transmissions can cause interference to the other system 440. Coexistence provides a solution for both concurrent and simultaneous operation within the multimode device.

In exemplary embodiments, there are three ways to implement coexistence in the MBRI system:
Seize and Hold Temporal Avoidance, where MBRI router transmits ‘channel hold’ transmissions to prevent WiFi from transmitting (2 ms in advance of data transfer).
Full-Frequency Avoidance, employing MBRI with DySAN (full 20 MHz RF channel bandwidth) to sense and adapt to avoid proximate WiFi activity.
Partial-Frequency Avoidance, employing MBRI sub-channel DySAN (2.5 MHz sub-channel BW) to spectrally operate in-between existing WiFi channels.

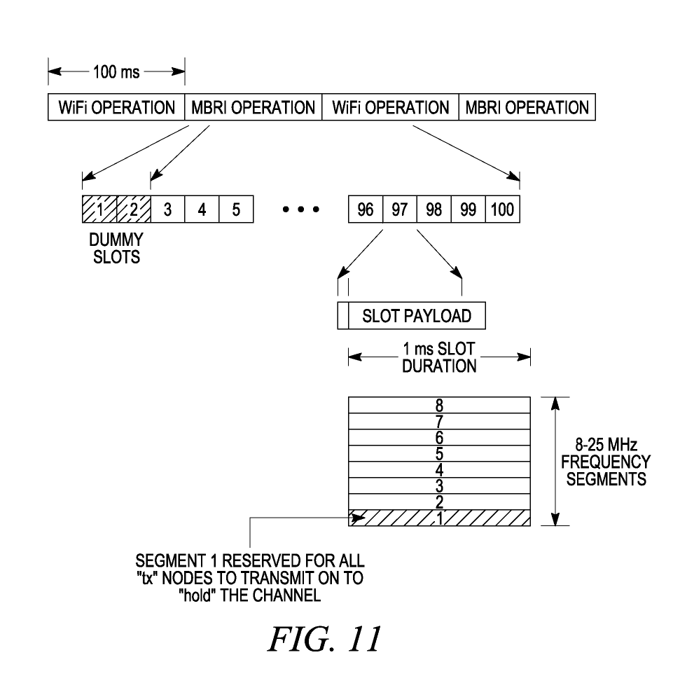

Seize and Hold Temporal Avoidance is illustrated in FIG. 11. Initially, the transmit timeline may be partitioned into segments designated for each technology (WiFi, MBRI), i.e., superframes. MBRI protocols operate using “punctured” timeline, which is a subset of available slots. In some embodiments, there are 96 slots in each MBRI interval. The first two slots (two DIFS windows, or 2 msec in duration, in this example) may be reserved as “dummy slot” transmissions at start of MBRI interval.

Legacy WiFi nodes unaware of timeline partitioning must be “tricked” into silence. The MBRI nodes are silent and/or sensing other RF channels during WiFi operation period. Nodes designated as “transmitters” on a given slot must transmit one segment every slot to hold the channel, i.e., to protect against pending 802.11 transmissions. Accordingly, in this exemplary embodiment, each slot has an inter-slot guard time of less than or equal to 34 μsec to prevent 802.11 transmissions. Since multiple nodes in a neighborhood are transmitting on segment 1, this “lost capacity” is filled with dummy data.

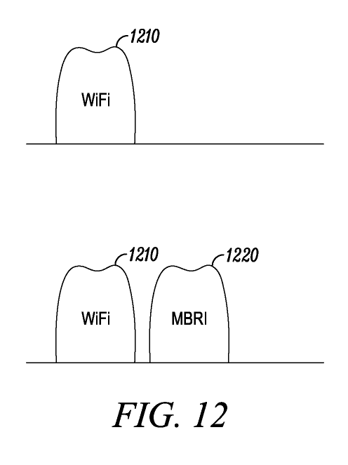

Full-Frequency Avoidance is illustrated in FIG. 12. This is the basic avoidance technique achieved using DySAN to select a vacant RF channel 1220 when a WiFi user 1210 is encountered. In some embodiments, it is employed upon start-up of the system and may be used for adaptation due to mobility or due to a changing environment (e.g., when a new emitter turns on nearby). The DySAN architecture and systems support multi-node operation across different RF channels to account for spatial RF occupancy pattern.

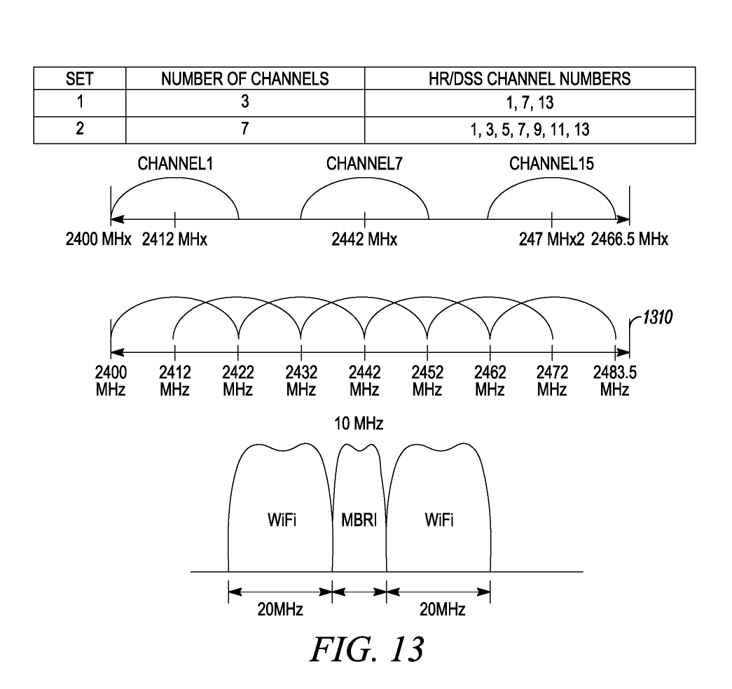

Partial-Frequency Avoidance is illustrated in FIG. 13. In certain environments, the unlicensed 2.4 GHz frequency band may contain multiple partially overlapping frequency channels 1310. DySAN control allows adaptive RF BW by turning segments (sub-channels) on/off.

### MBRI Device Integration

In embodiments, the MBRI Management technology may be embodied in a four layer ISO (International Standards Organization) OSI (Open Systems Interconnection) reference model stack. Layer 1, the physical (PHY) layer, uses a symmetrical waveform based on, for example and not by way of limitation, OFDMA, QAM, SC-OFDMA, CDMA, or TDMA technology. The waveform allows for bi-directional communications without a downlink or uplink protocol difference and relies on higher layer entities to manage output power, transmission mode, traffic types, and time synchronization functions. Layer 2, the media access control (MAC) layer, provides a high quality peer-to-peer packet transmission/reception protocol for passing frames between nodes and for distinguishing between peer-to-peer, peer to network, and network to peer traffic. The MAC layer also manages the radio resources of a single node and control subnetwork layer convergence functions such as segmentation and reassembly, quality of service (QoS), throughput fairness, adaptive data rate control and transmit power control. Layer 2 may be extensible to support the MAC functions and PHY functions for WiFi with integrated 3^{rd} party Application Programming Interfaces (APIs) for WiFi MAC functions of 3^{rd} party silicon solutions. Layer 3, the network layer, provides for full transparency with the internet through a border gateway protocol edge router, and makes transparent all TCP/IP and UDP functions at the routing level viz. OSPF. The router may also be responsible for application awareness, multicast and unicast operations and IPv4 and IPv6 transparency. The router may be able to concurrently support MBRI and WiFi traffic streams and IP services without enhancement. Furthermore, the router layer may weight the traffic based on “least cost” metrics or other proprietary rules. Layer 4 may be the OSS applications, which may be based on prevailing web standards and OSS standards. Layer 4 may be an open access layer and support the ad hoc downloading and development of custom or network-wide client applications, applets, servlets, and protocols. Layer 4 may also allow for the development of custom and open gateways and protocols for 3^{rd} party facilities, database, signaling and media access, and control. Layer 4 may be an open layer available to any type of Java, C++, and C programming language extensions through beans, Applet, servlet, thin client or fat client applications or installations. These extensions may embody open or closed proprietary protocols or applications as long as they may be web service open architecture compliant (i.e. downloadable and manageable over the web).

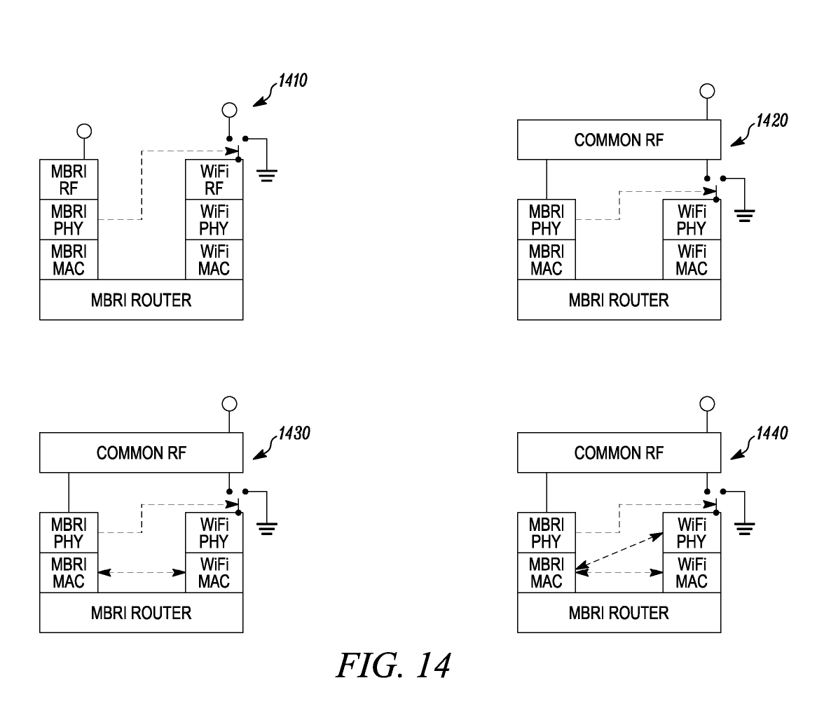

FIG. 14 depicts four alternate embodiments 1410, 1420, 1430, and 1440, representing different levels of multi-mode device integration for implementing an MBRI router according to some embodiments of the present invention. Block diagram 1410 represents two complete solutions in a single device, where an MBRI router is aware of WiFi interface. In this implementation, the antenna could be shared. The MBRI places a “blanking signal” on the RF front-end of co-device WiFi.

Alternatively, in block diagram 1420, the RF chain is shared with multiple MAC interfaces. In a further alternative embodiment 1430 with a shared RF chain, message passing and/or information sharing between MAC layers is also provided. In yet a further embodiment 1440 with a shared RF chain, the MBRI elements provide command of the WiFi “utility” transmissions.

These multimode devices may be configured, in some exemplary embodiments, to operate in a number of different ways. For example, when operating in an “either/or” or “Multiple Personality” mode, the MBRI and WiFi systems can be operated in any of the following configurations:
MBRI network primary; WiFi network secondary
Node boots-up and searches for MBRI network
Node participates in MBRI network until “out-of-network” for some defined duration
Node searches for WiFi network
If found, node joins WiFi network, else alternates search for MBRI and WiFi networks
While part of WiFi network, node periodically searches for MBRI network

If, however, the MBRI and WiFi systems are operating simultaneously, the node participates in both MBRI and WiFi networks (i.e., separate NICs). This may include operation in the temporal co-existence scenario with channel change (if needed) between alternating technology superframes. The MBRI operation duty cycle is adaptive based on observed dynamic traffic requirements of both networks, because the MBRI router is aware of both network interfaces and can route through either. As noted above, the MBRI network uses DySAN on both full and partial channels to find “free” spectrum.

Embodiments utilizing 802.11 Network Chipsets

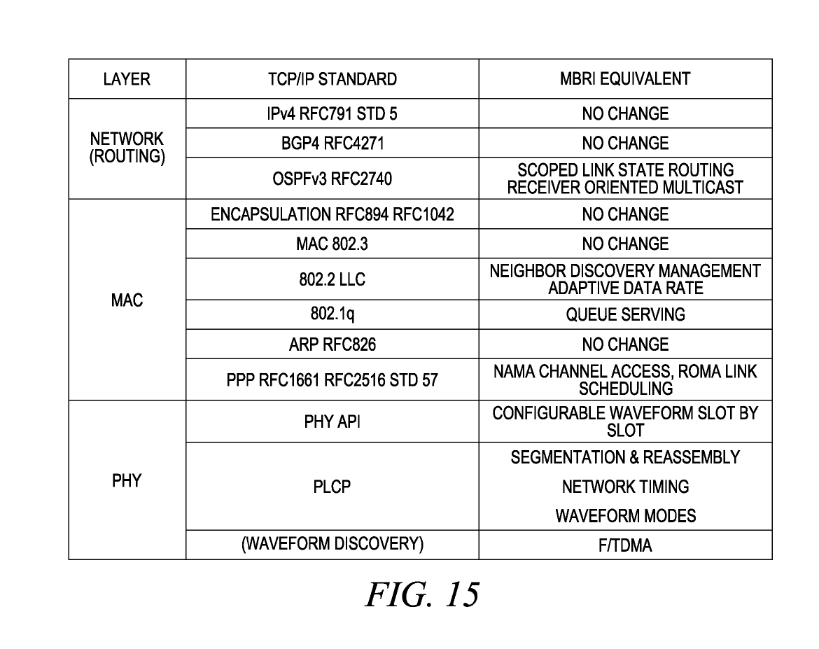

As shown in FIGS. 15-17, an ad hoc network modem (or device using such a modem) for use in an MBRI network or the like may be realized using existing chipsets designed for operation within the 802.11 wireless network standard, or more specifically, protocols for wireless networking such as 802.11a, 802.11b, 802.11g, and 802.11n described within the IEEE 802.11-2007 standard, which is hereby incorporated by reference in its entirety.

FIG. 15 illustrates the upper layers of a protocol stack for a wireless networking system according to one embodiment of the present invention. These layers may, in an exemplary embodiment, be ported to the WiFi physical (PHY) layer, such as in an API between a physical layer radio and an 802.11 chipset, and therefore utilize the various WiFi waveform modes including those based on well known access methods, such as but not limited to FHSS, DSSS, OFDMA, and the like. This allows routing and MAC layer protocols to provide various network services or functions described herein such as ad hoc, peer-to-peer, self-forming, self-healing, geolocation, neighborhood routing, and control and edge to edge scalability and routing capabilities of the MBRI networks described above, while also taking advantage of commercial off the shelf WiFi components designed according to the 802.11 standard such as chips, modules, boards, host processors and dongles.

This approach may also enable deployment of various features and advantages of MBRI network systems described herein across a pre-existing base of existing WiFi products. For example, this may be applied to an existing infrastructure of WiFi networks and hotspots by permitting a download of MBRI software as host based drivers and software without requiring hardware retrofit or software changes to existing products, terminals, devices and Access Points. The software described herein may, for example, be downloaded and installed remotely using any of a variety of well-known, commonly-used installation techniques including without limation install shields, wizards, FTP, TFTP, FTAM, and the like, or any other suitable techniques and/or protocols for file transfer, file installation, firmware upgrade, and so forth.

In this manner, WiFi can be enhanced to provide capabilities for ad hoc wireless networking as described herein including dynamic mobile routing, peer-to-peer routing and communications, ad hoc network build-out, dense spectrum reuse, co-channel cooperation (as opposed to co-channel competition), graceful scaling, graceful saturation, session persistence across the network, full mobility across the network, non-GPS based geolocation using time difference of arrival (TDOA), ability to leverage applications such as swarming, rapid nodal births and deaths, full OSPF and Border Gateway Protocol (BGP) transparency with MBRI radio aware routing.

Furthermore, this approach addresses one drawback of deployments of new wireless network infrastructure—the need for new radio or modem hardware—by allowing an MBRI or other ad hoc wireless network to deploy on top off existing WiFi networks (or beneath existing networks, for the point of view of the network protocol) by installing suitable software in various access points, devices, dongles, laptops, smart phones, PC cards, chips, and the like across an existing WiFi network. Thus, this approach advantageously permits deployment of new networks while mitigating the need for a wholesale replacement of network-related hardware.

Existing WiFi devices are generally built with commercial off-the-shelf (COTS) 802.11-based modems. It is therefore desirable to be able to implement an ad hoc wireless network stack on these COTS chipsets. The COTS modems (or chipsets) are generally designed for mass-market adoption. Their low cost drives high volume. They are generally single carrier designs for a specific market band or bands. They are primarily single hop, point-to-point transmission systems.

Typical COTS 802.11 modem chipset implementations focus on maximum throughput for a target end-user application; they have few transmission modes and back-off options. Because they are built to address specific standards, these chipsets typically have few options for adaptability to other market requirements or usage scenarios. However, silicon providers do provide maximum options for utilization in other market environments, including support of multiple bus types and operating systems.

COTS 802.11 modem chipsets are also designed to preserve or optimize battery life in end-user devices and have multiple options for sleep mode and multiple options to preserve power including adaptive power control. The PHY and MAC layer functions are usually separated, with open MAC drivers to enable software customization. The present invention takes advantage of these aspects of COTS 802.11 chipsets to add an enhanced software stack onto COTS chips in order to implement the various modem and/or router functions described above using low-cost, commercially available hardware. The operation of 802.11 chipsets is well known in the art, and is not discussed in detail here except to the extent that it relates to adaptations of such chipsets to other wireless networking platforms.

The latest generation of WiFi chips supports a hardware state machine for the PHY and the MAC functions that is entirely in software. So-called “thick driver” implementations for host based drivers e.g. for Windows and Apple platforms are also currently available. In addition, thin implementations for on-board or real-time operating systems are available.

Implementation of an enhanced or otherwise customized network stack is aided by the fact that several features of a typical OTS chipset can be turned off via register control and set up at initialization including. This includes, for example, ACK/NAK handling (optional to begin with) and RTS/CTS, which is an optional 802/11 e feature. In one aspect, the OTS chipset may be operated without disabling Carrier Sense Multiple Access with Collision Avoidance (“CSMA/CA”) processing, even though this feature interferes with the protocols and MAC control algorithms used in MBRI or the like. In a CSMA network, a node wishing to transmit data has to first listen to the channel for a predetermined amount of time to determine whether another node is transmitting on the channel within the wireless range. If the channel is sensed as idle, then the node is permitted to begin the transmission process. If the channel is sensed as busy, the node defers its transmission for a random period of time.

In addition, in some embodiments of the present invention, the software must implement a “Timeslot API” and configure the 802.11 chipset into a slotted time-division multiple access (TDMA) mode, since it is already time-division duplexing (TDD) in nature. Furthermore, the standard 802.11 Distributed Coordination Function (“DCF”) InterFrame Space (DIFS) processing can also be turned off via register control. As a result, all station interference, collisions, back-off timing and scheduling may be placed under control of an API for the chipset, rather than the PHY functions of the chipset. This allows an overlay of control protocols (such as MBRI or any other suitable wireless networking protocol(s)) to determine slot winners and losers in a neighborhood.

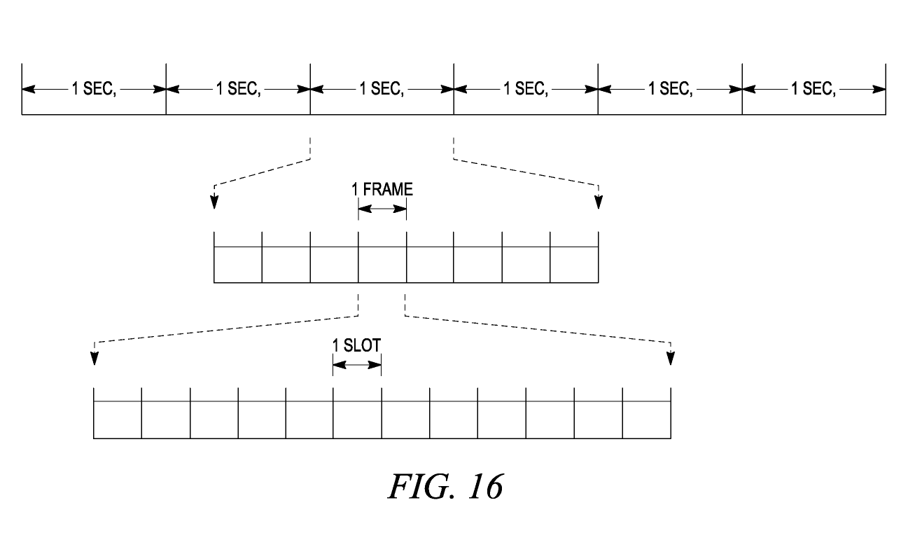

FIG. 16 depicts a slotted TDMA timing structure according to one embodiment of the present invention. Each time interval is subdivided into multiple epochs. There is a one pulse per second (pps) signal from the GPS in each access point and an artificially generated one pps signal in subscriber devices. Each one second interval may be subdivided into an integer number of frames and each frame further subdivided into an integer number of slots per frame. The fundamental slot rate in number of slots per second is 1000 slots/sec. nominal (1 msec each). Slot transmissions may be scheduled by means of algorithms well known in the art.

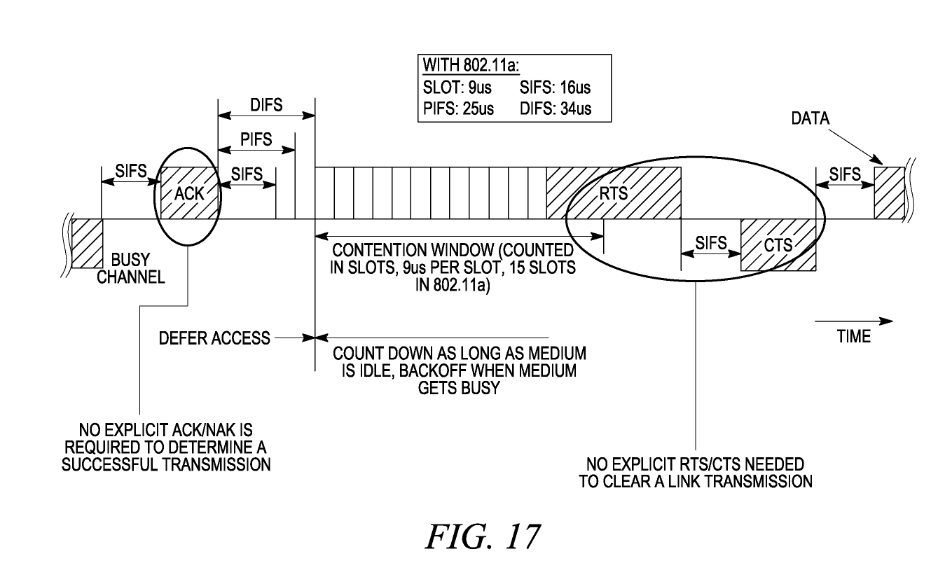

FIG. 17 illustrates some aspects of the current 802.11 timing and message passing scheme that can be avoided in an exemplary embodiment of an enhanced network protocol. Using MBRI and DySAN co-channel cooperation technology (or other suitable technology) allows nodes to asynchronously determine slot winners in their neighborhood based on various node metrics without explicit radio contention. Accordingly, the explicit ACK/NAK and RTS/CTS messages are not required. Furthermore, link scheduling algorithms prevent link contention between neighborhoods. Since the CSMA/CA function is based on the Distributed Coordination Function in the standard 802.11 MAC layer implementation, the back-off procedure would be initiated after an idle time of DIFS. However, in an MBRI and DySAN embodiment (or similar network protocol(s)), the network layer avoids collisions by scheduling transmit times for nodes. Thus, the DIFS processing can also be disabled.

To summarize, the MAC-PHY Layer interactions in embodiments of the present invention may include the following:

802.11 Standard API example
Receive:
   [symbol] PHY_CCA.ind—Clear channel indication from PHY (Busy/Idle)
   [symbol] PHY_RXSTART.ind—Indication from PHY that receive has begun; includes Length and RSSI parameters
   [symbol] PHY_DATA.ind—Indication from PHY that data is arriving
   [symbol] PHY_TXEND.ind—Indication from PHY that transmission has ended
Transmit:
   [symbol] PHY_TXSTART.req—Instruction to PHY to initiate transmission; includes parameters: Length, Data Rate, Service, TXPWR_LEVEL
   [symbol] PHY_TXSTART.conf—Confirmation from PHY that transmission has begun
   [symbol] PHY_DATA.req—Request to PHY for data transmission
   [symbol] PHY_DATA.conf—Transmission confirmation from PHY
   [symbol] PHY_TXEND.req—“End of Transmission” signal sent to PHY
   [symbol] PHY_TXEND.conf—“End of Transmission” confirmation from PHY
MBRI API, where extensions to the standard 802.11 API are noted in italics
Receive:
   [symbol] I PPS signal
   [symbol] PHY_RXSTART.ind—Indication from PHY that receive has begun; includes Length and RSSI parameters plus SNR
   [symbol] PHY_DATA.ind—Indication from PHY that data is arriving plus slot number information
   [symbol] PHY_TXEND.ind—Indication from PHY that transmission has ended
Transmit:
   [symbol] PHY_TXSTART.req—Instruction to PHY to initiate transmission; includes parameters: Length, Data Rate, Service, TXPWR_LEVEL plus slot number information
   [symbol] PHY_TXSTART.conf—Confirmation from PHY that transmission has begun
   [symbol] PHY_DATA.req—Request to PHY for data transmission
   [symbol] PHY_DATA.conf—Transmission confirmation from PHY
   [symbol] PHY_TXEND.req—“End of Transmission” signal sent to PHY
   [symbol] PHY_TXEND.conf—“End of Transmission” confirmation from PHY

In addition, the MBRI implementation includes a timeslot API (described above) that passes packets between an enhanced network MAC and the 802.11p PHY layers of an 802.11 chipset.

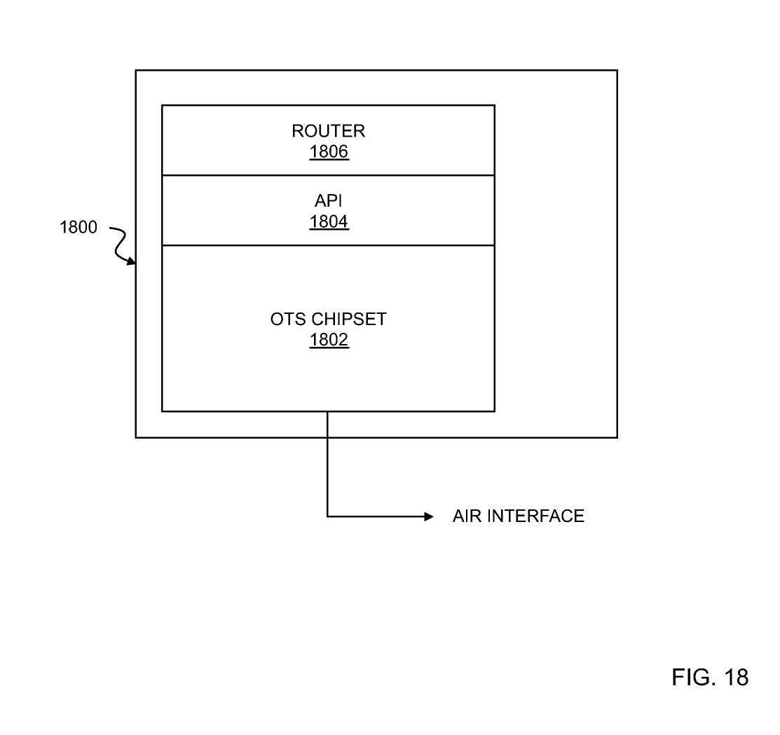

FIG. 18 shows an apparatus adapting an OTS 802.11 chipset to use with an enhanced network protocol. In generally, a device 1800 described herein includes an off-the-shelf (OTS) chipset 1802 and an application programming interface (API) 1804 to a router 1806 for enhanced networking The device 1800 may be any wireless device participating in a wireless network such as a mobile ad hoc wireless network including without limitation a cellular phone, a laptop computer, a notebook computer, a netbook, an iPhone, an iPad, an iPod, or any other wireless device or network element that might transmit or receive data within the wireless network.

The OTS chipset 1802 may, for example, be a commercially available chipset implementing an 802.11a, 802.11b, 802.11g, or 802.11n wireless networking protocol, or some combination of these. In general, the OTS chipset 1802 encodes/decodes data between the device 1800 and the air interface according to one or more predetermined protocols. It will be understood that while the OTS chipset 1802 is depicted as separate hardware on the device 1800, the OTS chipset 1802 may include a plurality of chips on a substrate, a system-on-a-chip (SOC), or a subsystem on an SOC chip that implements a standard silicon version of the desired 802.11 functions plus the API 1804 and/or other subsystems of the device 1800 onto a single chip and/or package. Thus the term “chipset” as used herein will be understood to include any one or more integrated devices that together perform the various functions described herein.

The API 1804 may be any suitable programming interface for adapting the OTS chipset 1802 to the enhanced network functions described herein. As described in the examples above, this may generally include one or more of disabling functions of the OTS chipset 1802 that directly interfere with an enhanced protocol, adapting functions of the OTS chipset 1802 to the enhanced protocol, and/or adapting one or more functions of the enhanced protocol to the built-in functions of the OTS chipset 1802. Thus for example where the enhanced protocol provides network scheduling (such as the MBRI protocol described above), collision sensing becomes unnecessary. The API 1804 may control the OTS chipset 1802 to suppress collision sensing, and to remove or restrict associated backoffs or the like that might otherwise interface with scheduling dictated by the router 1806. The API 1804 may be implemented in a variety of forms including a processor or other processing circuitry configured with software, firmware, or other program code to support an interface as described herein between the PHY layer of a chipset and the MAC layer of a router. The processor and/or code may be realized as a processor separate from the router and chipset, or the processor and/or code may be realized in whole or in part within the router and/or the chipset. More generally, the API 1804 may be realized as code executing on a processor on the device 1800, an interface executing on an SOC along with the OTS chipset 1802, or any other combination of software and/or hardware suitable for handling communications between, e.g., an enhanced network protocol used by the router 1806 and an 802.11 protocol used by the OTS chipset 1802. Where the OTS chipset 1802 provides supplemental processing capability, the API 1804 may be implemented on the OTS chipset 1802. In another aspect, the API 1804 may be implemented within the router 1806 to support use with a corresponding chipset such as an 802.11-compliant chipset that includes one or more chips implementing an 802.11 wireless networking standard.

The router 1806 may in general be any combination of hardware and/or software that implements elements of an enhanced network protocol above the physical layer for ad hoc wireless networking such as the MBRI protocol described above. The various functions of an MBRI network element are described in greater detail above, all by way of illustrative examples of an enhanced network protocol rather than by way of limitation. Any variations that would be apparent to one of ordinary skill in the art are intended to fall within the scope of this disclosure.

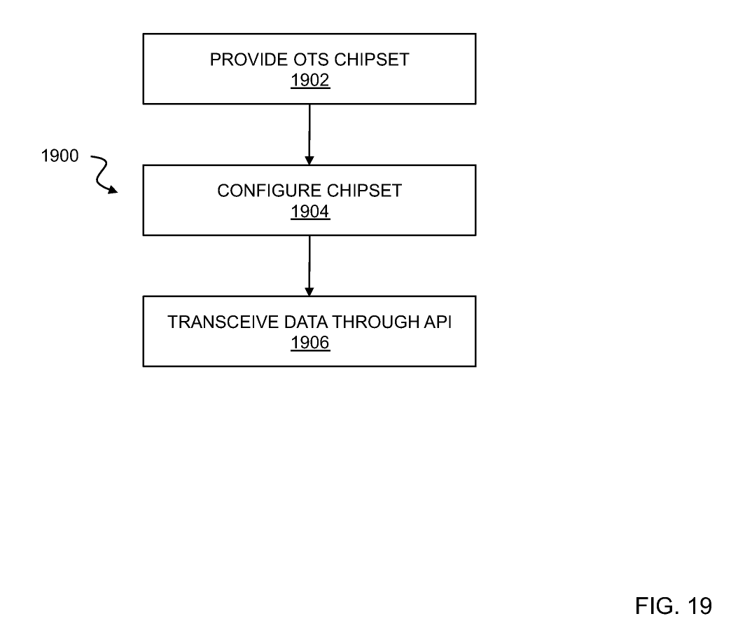

FIG. 19 shows a flow chart of a process for communicating in a wireless ad hoc network using an 802.11 chipset. As shown in step 1902, the process 1900 may begin with providing an OTS chipset. This may for example include powering on an OTS chipset such as an 802.11-compliant chipset including one or more chips on a device such as any of the devices described above, or this may include related steps such as establishing a communicating relationship between a radio front end of an OTS chipset and a compatible wireless network.

As shown in step 1904, the chipset may be configured. This may include disabling various features of the chipset. For example, this may include disabling CSMA/CS processing as described above. This may also or instead include disabling ACK/NAK handling of the chipset, disabling RTS/CTS handling by the chipset, and/or disabling DIFS processing by the chipset. This may also include configuring the chipset into a slotted TDMA mode, or otherwise configuring the chipset to operate consistently with the enhanced protocol. This may also or instead include configuring the chipset to provide supplemental data on a packet-by-packet basis, or any other basis available from the chipset and consistent with the processing requirements of an enhanced protocol router.

As shown in step 1906, data may be transceived between the chipset and a router through an API. More specifically, this may include transferring a packet containing data between the PHY layer of the chipset and the MAC layer of an enhanced protocol supported by the router. The API may in general adapt data packets to bridge the differences between the communication interfaces of the router and the chipset. While bridging different protocols may generally be known, the disclosed system can advantageously and more specifically support the distributed network scheduling and other advanced features of an enhanced network protocol such as MBRI through a hardware radio built on a native CSMA technology. Transceiving data according to step 1906 may include one or more of the following general operations.

First, the API may coordinate configuration of the chipset 1904 so that the chipset provides information such as received signal strength (via an RSSI indicator) or signal to noise ratio (SNR) that the router uses for network scheduling and the like. The API may also or instead calculate a timing signal and periodically provide this to the chipset for communication over an air interface. In this configuration, the API effectively provides a physical layer service of the enhanced protocol by controlling the chipset to periodically send a timing signal. In another aspect, the timing signal may be controlled or synchronized by the router or other higher-level layer of the enhanced protocol stack.

Second, the API may process data received by the chipset from a wireless network into a format suitable for the router using a timeslot. In general, a chipset will receive a radio frequency signal, and process the radio frequency signal to compose a packet containing data and a header according to any protocol that controls operation of the chipset. For an 802.11 chipset, this excludes information such as various node and link metrics that can be used by an enhanced protocol router to schedule network communications and the like. As such, the API may assemble a different header for the data that conforms to the router protocol. This may, for example, include obtaining an RSSI parameter for a packet from the chipset and adding the RSSI parameter to the packet header. This may also or instead include adding a timeslot number parameter for the packet. The timeslot number parameter may be translated between timeslot numbers used by the chipset and timeslot numbers used by the router, or this parameter may be simply received from the chipset and included in the header of a packet provided to the MAC layer.

Third, the API may process data received from the router into a format suitable for presentation to the PHY layer of the chipset. This would include various header manipulations corresponding to the differences in format and content between the PHY layer of the chipset and the MAC layer of the router, as generally discussed above. Thus information in the MAC layer header may generally be removed, re-ordered, or transformed for use in the chipset protocol stack. Information such as a timeslot number may further be used to place a data packet within a desired timeslot of the chipset TDMA signal.

Thus in general, transceiving data through the API may include transceiving a plurality of packets and converting a header of each packet between a format for a chipset and a format for a router using a different protocol than the chipset. Transceiving the plurality of packets may for example include adding at least one of the RSSI parameter and an SNR parameter to the header of each one of the plurality of packets received by the MAC layer of the enhanced protocol from the PHY layer of the chipset. In a complementary fashion, transceiving the plurality of packets may also or instead include removing at least one of the RSSI parameter and an SNR parameter from the header of each one of the plurality of packets received by the PHY layer of the chipset from the MAC layer of the enhanced protocol.

### Alternate Embodiments

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer program product or computer executable code (which may be stored in memory) created using a structured programming language such as (but not limited to) C, an object oriented programming language such as (but not limited to) C++, or any other high-level or low-level programming language (including but not limited to assembly languages, hardware description languages, and database programming languages and technologies) that may be stored, executed, compiled or interpreted to run on one of the above devices, as well as heterogeneous combinations of processors, processor architectures, or combinations of different hardware and software.

Thus, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method for wireless communication comprising:
providing a chipset including one or more 802.11-compliant chips;
configuring the chipset to disable CSMA/CS processing;
configuring the chipset into slotted TDMA mode; and
transceiving data through an API configured to extend operation of the chipset to an enhanced protocol for a wireless ad hoc network including:
passing a packet between a PHY layer of the chipset and a MAC layer of the enhanced protocol using at least a timeslot;
exchanging at least an RSSI parameter and a timeslot number parameter for the packet; and
providing a timing signal for transmission over an air interface by the chipset.

2. The method of claim 1 further comprising:
disabling ACK/NAK handling of the chipset; and
disabling RTS/CTS handling by the chipset.

3. The method of claim 1 further comprising disabling DIFS processing by the chipset.

4. The method of claim 1 wherein transceiving data through the API further comprises exchanging a SNR parameter for the packet.

5. The method of claim 1 further comprising transceiving a plurality of packets through the API, each one of the packets having a header, and each one of the headers converted by the API between a format for the chipset and a format for the enhanced protocol.

6. The method of claim 5 wherein transceiving the plurality of packets includes adding at least one of the RSSI parameter and an SNR parameter to the header of each one of the plurality of packets received by the MAC layer of the enhanced protocol from the PHY layer of the chipset.

7. The method of claim 5 wherein transceiving the plurality of packets includes removing at least one of the RSSI parameter and an SNR parameter from the header of each one of the plurality of packets received by the PHY layer of the chipset from the MAC layer of the enhanced protocol.

8. A computer program product for communicating in a wireless ad hoc network, the computer program product embodied in a non-transitory computer readable medium that, when executing on one or more computing devices, performs the steps of:
configuring a chipset that includes one or more 802.11-compliant chips to disable CSMA/CS processing;
configuring the chipset into slotted TDMA mode; and
transceiving data through an API configured to extend operation of the chipset to an enhanced protocol for the wireless ad hoc network including:
passing a packet between a PHY layer of the chipset and a MAC layer of the enhanced protocol using at least a timeslot;
exchanging at least an RSSI parameter and a timeslot number parameter for the packet; and
providing a timing signal for transmission over an air interface by the chipset.

9. The computer program product of claim 8 further comprising code that performs the steps of:
disabling ACK/NAK handling of the chipset; and
disabling RTS/CTS handling by the chipset.

10. The computer program product of claim 8 further comprising code that performs the step of disabling DIFS processing by the chipset.

11. The computer program product of claim 8 wherein transceiving data through the API further comprises exchanging a SNR parameter for the packet.

12. The computer program product of claim 8 further comprising code that performs the step of transceiving a plurality of packets through the API, each one of the packets having a header, and each one of the headers converted by the API between a format for the chipset and a format for the enhanced protocol.

13. The computer program product of claim 12 wherein transceiving the plurality of packets includes adding at least one of the RSSI parameter and an SNR parameter to the header of each one of the plurality of packets received by the MAC layer of the enhanced protocol from the PHY layer of the chipset.

14. The computer program product of claim 12 wherein transceiving the plurality of packets includes removing at least one of the RSSI parameter and an SNR parameter from the header of each one of the plurality of packets received by the PHY layer of the chipset from the MAC layer of the enhanced protocol.

15. A device for wireless communication comprising:
a chipset including one or more 802.11-compliant chips, the chipset configured to disable CSMA/CS processing and the chipset configured into slotted TDMA mode; and
a processor configured to provide an API that extends operation of the chipset to an enhanced protocol for a wireless ad hoc network, the API operable to:
pass a packet between a PHY layer of the chipset and a MAC layer of the enhanced protocol using at least a timeslot;
exchange at least an RSSI parameter and a timeslot number parameter for the packet; and
provide a timing signal for transmission over an air interface by the chipset.

16. The device of claim 15 wherein the chipset is further configured to disable ACK/NAK handling and to disable RTS/CTS handling.

17. The device of claim 15 wherein the chipset is further configured to disable DIFS processing.

18. The device of claim 15 wherein the API is operable to exchange a SNR parameter for the packet.

19. The device of claim 15 wherein the API is operable to transceive a plurality of packets, each one of the packets having a header, and each one of the headers converted by the API between a format for the chipset and a format for the enhanced protocol.

20. The device of claim 19 wherein the API is operable to add at least one of the RSSI parameter and an SNR parameter to the header of each one of the plurality of packets received by the MAC layer of the enhanced protocol from the PHY layer of the chipset.

21. The device of claim 19 wherein the API is operable to remove at least one of the RSSI parameter and an SNR parameter from the header of each one of the plurality of packets received by the PHY layer of the chipset from the MAC layer of the enhanced protocol.
